(19) United States
(12) Patent Application Publication
(10) Pub. No.: US 2026/0341258 A1
(43) Pub. Date: Oct. 29, 2026

(54) SOUND ABSORBING APPARATUS

(71) Applicant: Korea Advanced Institute of Science and Technology, Daejeon (KR)

(72) Inventors: Wonju Jeon, Daejeon (KR); Yerin Shim, Daejeon (KR)

(21) Appl. No.: 19/427,147

(22) Filed: Dec. 19, 2025

(30) Foreign Application Priority Data
Apr. 25, 2025 (KR) 10-2025-0054252
Jul. 1, 2025 (KR) 10-2025-0087611

(51) Int. Cl. G10K 11/172; G10K 11/04; G10K 11/162

(52) U.S. Cl. CPC G10K 11/172; G10K 11/04; G10K 11/162

(57) ABSTRACT

Provided is a sound absorbing apparatus including a unit cell for sound absorption, wherein the unit cell for sound absorption includes at least two resonators having different resonance frequencies, the resonators including a cavity portion having a hollow space therein, a neck portion connected to the cavity portion and having a neck communicating the space with an exterior, and a cover for adjusting a neck opening ratio, and the resonators included in the unit cell for sound absorption have different resonance frequencies by having different neck opening ratios set by the cover.

### CROSS-REFERENCE TO RELATED APPLICATIONS

This application claims priority under 35 U.S.C. § 119 to Korean Patent Application No. 10-2025-0054252, filed on Apr. 25, 2025, and Korean Patent Application No. 10-2025-0087611, filed on Jul. 1, 2025, in the Korean Intellectual Property Office, the disclosure of each of which is incorporated herein by reference in its entirety.

### TECHNICAL FIELD

The following disclosure relates to a sound absorbing apparatus, and more particularly, to a sound absorbing apparatus using an acoustic metasurface that provides high-efficiency sound absorbing performance while having a small thickness in a low-frequency band.

### BACKGROUND

A sound absorbing apparatus, which effectively reduces ambient noise, may serve an important function in daily life and industrial sites. A sound absorption method may be classified into porous, plate-shaped, and resonant types. The porous type may improve a sound absorption rate at a specific frequency, and the resonant or plate-shaped type may improve performance by modifying an internal structure. However, technologies in this field face limitations in achieving high absorption of sound at low frequencies within compact structures.

Low-frequency noise occurring in mechanical equipment may mainly be structural noise, and noise absorption may be a key to noise reduction. Typical porous materials or resonant structures do not effectively absorb low frequencies in a range of tens to hundreds of hertz (Hz). Therefore, a technology is required to achieve high-efficiency sound absorbing performance in the low-frequency band while having a small thickness structure.

The disclosure of this section is to provide background information relating to the present disclosure. Applicant does not admit that any information contained in this section constitutes prior art.

### SUMMARY

An acoustic metasurface shows a possibility of absorbing low frequencies while having a small thickness compared to the corresponding wavelengths. However, a typical acoustic metasurface using a single resonance mode has a narrow absorption bandwidth. To address this, an acoustic metasurface that exploits hybrid resonance may be provided. The acoustic metasurface based on hybrid resonance may include a structure using a membrane and different subwavelength Helmholtz resonators. The neck radii of the Helmholtz resonators may be varied, or membranes may be embedded at different position within the cavities, thereby inducing hybrid resonance between different resonance modes.

Although the metasurface composed of Helmholtz resonators with non-uniformly partitioned cavities can achieve perfect sound absorption at the same target frequency while being thinner than the metasurface that uses Helmholtz resonators with varying neck radii, its sound absorbing performance is limited by a narrow absorption bandwidth.

In addition, technology capable of absorbing discrete frequencies and broad frequency ranges is required to reduce tonal and broadband noise caused by turbulence in mechanical systems with periodic motion. However, sound absorption technology using the typical acoustic metasurface is limited in its ability to change a frequency band because a frequency that requires the sound absorption varies depending on the rotational or periodic motion.

In addition, if a manufacturing error occurs, not only is the perfect sound absorption impossible, but the sound absorbing performance may also be deteriorated. In addition, the structure in which the membrane, which is sensitive to tension, is installed inside the cavity is limited in its ability to accurately adjust the tension, thus making installation and maintenance/repair difficult. Accordingly, the aforementioned technologies require high manufacturing accuracy and a complex structure, which makes it difficult to apply to the industrial sites.

An embodiment of the present disclosure is directed to providing a sound absorbing apparatus capable of responding to various frequencies without changing a resonator structure by adjusting an opening ratio of a resonator neck.

An embodiment of the present disclosure is also directed to providing a sound absorbing apparatus capable of exhibiting excellent sound absorbing performance while having a small thickness and enabling multiple-frequency and broadband sound absorption by using a broad absorption bandwidth.

An embodiment of the present disclosure is also directed to providing a sound absorbing apparatus adapted to a surrounding environment by adjusting a sound absorption frequency based on the ambient noise.

An embodiment of the present disclosure is also directed to providing a sound absorbing apparatus having a broad sound absorption bandwidth and high sound absorbing performance at a target frequency by using a simple adjustment method.

Aspects of the present disclosure are not limited to those mentioned above, and other aspects not mentioned here may be clearly understood by those skilled in the art from the following description.

In one general aspect, provided is a sound absorbing apparatus including a unit cell for sound absorption, wherein the unit cell for sound absorption includes at least two resonators having different resonance frequencies, the resonators including a cavity portion having a hollow space therein, a neck portion connected to the cavity portion and having a neck communicating the space to an exterior, and a cover for adjusting a neck opening ratio, and the resonators included in the unit cell for sound absorption have different resonance frequencies by having different neck opening ratios set by the cover.

In another general aspect, provided is a sound absorbing apparatus including a unit cell for sound absorption, wherein the unit cell for sound absorption includes at least two resonators having different resonance frequencies, the resonators including a cavity portion having a hollow space therein, a neck portion connected to the cavity portion and having a neck communicating the space to an exterior, and a cover for adjusting a neck opening ratio, and the resonators included in the unit cell for sound absorption have different resonance frequencies by having different cover positions.

In another general aspect, provided is a sound absorbing apparatus including a unit cell for sound absorption, wherein the unit cell for sound absorption includes at least two resonators having different resonance frequencies, the resonators include a cavity portion having a hollow space therein, a neck portion connected to the cavity portion and having a neck communicating the space to an exterior, and a cover for adjusting a neck opening ratio, and the resonators included in the unit cell for sound absorption have different resonance frequencies by having different cover shapes or thicknesses.

The cover may partially or entirely open or close the neck.

One cover may be provided, or a plurality of covers may be combined to adjust the neck opening ratio.

The cover may be provided as an aperture structure in which at least one plate-shaped vane is combined to form at least one hole, and a cross-sectional area of the neck is changeable by moving the vane to adjust a hole size.

One unit cell for sound absorption may be provided.

The plurality of unit cells for sound absorption may be arranged periodically on a plane.

The resonators may be randomly disposed within the unit cell for sound absorption at a distance sufficient to cause resonance with each other.

The resonators having different resonance frequencies may be arranged alternately in a first direction, the resonators having the same resonance frequency may be disposed in a second direction perpendicular to the first direction, and the resonators having different resonance frequencies may be arranged diagonally relative to each other.

The resonators having different resonance frequencies may be disposed alternately in the first direction and the second direction.

The cover may extend in the second direction, have a size and a shape capable of collectively adjusting the neck opening ratio of the resonator disposed in the second direction, and be movable in the first direction.

The apparatus may further include: a guiding rail on which the cover is mounted and which extends in the first direction; and an actuator for moving the cover in the first direction on the guiding rail.

The cover may be coupled to the front or rear of the neck.

The cover may have a plate shape having a hole formed therein, and be disposed within the neck.

The cover may be movable within the neck.

A protrusion may be formed on the cover, a groove may be formed within the neck along a length direction of the neck to correspond to the protrusion, and the cover may slide along the groove.

A cross-sectional area of the neck portion may be smaller than a cross-sectional area of the cavity portion.

The apparatus may further include: a noise sensor for measuring ambient noise; and a controller for controlling the cover to adjust the neck opening ratio based on noise measured using the noise sensor, wherein the controller adjusts the neck opening ratio or a position of the cover within the neck to implement an optimal resonance frequency matching the ambient noise.

Other features and aspects will be apparent from the following detailed description, the drawings, and the claims.

The sound absorbing apparatus according to the embodiments of the present disclosure may respond to the various frequencies without changing the resonator structure by adjusting the neck opening ratio.

The sound absorbing apparatus according to the present disclosure may also exhibit the excellent sound absorbing performance while having the small thickness, and enable the multiple-frequency and broadband sound absorption by using the broad absorption bandwidth.

The sound absorbing apparatus according to the present disclosure may also adjust the sound absorption frequency based on the ambient noise.

The present disclosure may also provide the sound absorbing apparatus having the high sound absorbing performance and the broad sound absorption bandwidth at the target frequency by using the simple adjustment method.

Advantageous effects of the present disclosure are not limited to those mentioned above, and other effects not mentioned here may be clearly understood by those skilled in the art from the above description.

### BRIEF DESCRIPTION OF THE DRAWINGS

FIG. 1 shows an appearance of a sound absorbing apparatus according to an embodiment of the present disclosure.

FIG. 2 shows an appearance of an aperture according to an embodiment of the present disclosure.

FIG. 3 shows an appearance of a neck according to another embodiment of the present disclosure.

FIG. 4 shows an appearance of a cover according to another embodiment of the present disclosure.

FIG. 5 shows an appearance of a sound absorbing apparatus according to another embodiment of the present disclosure.

FIG. 6 shows a result of comparing a figure of merit (FOM) of comparative hybrid resonance devices with the sound absorbing apparatus according to an embodiment of the present disclosure.

FIGS. 7 and 8 respectively show appearances of a neck portion according to other embodiments of the present disclosure.

### DETAILED DESCRIPTION OF EMBODIMENTS

Hereinafter, embodiments of the present disclosure are described in detail with reference to the accompanying drawings so that those skilled in the art to which the present disclosure pertains may easily practice the present disclosure. However, the present disclosure may be modified in various different forms, and is not limited to the embodiments provided herein. In addition, in the drawings, portions unrelated to the description are omitted to clearly describe the present disclosure, and similar portions are denoted by similar reference numerals throughout the specification.

Throughout the specification, when one part is referred to as being “connected to” another part, one part and another part may be “directly connected to” each other, or may be “electrically connected to” each other with a third part interposed therebetween.

Throughout the specification, when one member is referred to as being disposed “on” another member, one member and another member may be in contact with each other, or a third member may be interposed between one member and another member.

Throughout the specification, “including” one component is to be understood to imply the inclusion of another component rather than the exclusion of another component, unless explicitly described to the contrary. As used throughout the specification, a term of degree such as “about”, “substantially”, or the like is used to indicate the number of a stated meaning or its approximation when its manufacturing or material tolerance inherent therein is given. Such a term is used to prevent unscrupulous infringers from unfairly using the present disclosure in which exact or absolute figures are stated to facilitate the understanding of this application. As used throughout the specification, a term such as a “step of (doing)” or a “step of~” does not indicate a “step for~”.

Hereinafter, the embodiments of the present disclosure are described in detail with reference to the accompanying drawings and the descriptions provided below. However, the present disclosure is not limited to the embodiments described herein, and may also be embodied in another form. The same reference numerals denote the same components throughout the specification.

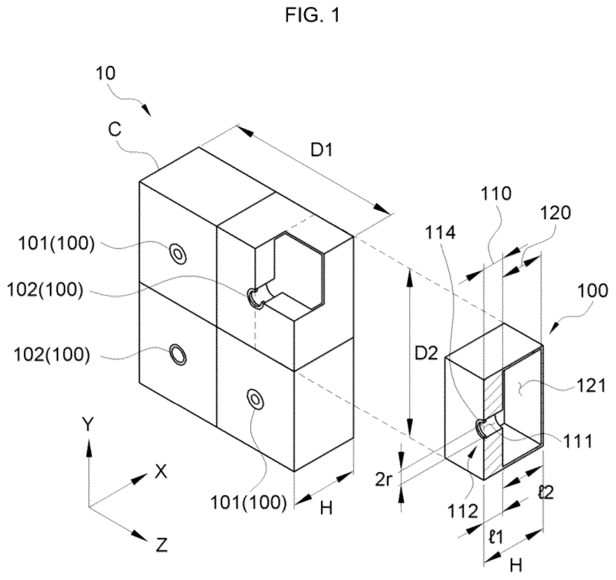

The present disclosure provides a sound absorbing apparatus 10. FIG. 1 shows an appearance of the sound absorbing apparatus 10 according to an embodiment of the present disclosure. Referring to FIG. 1, the sound absorbing apparatus 10 may include a plurality of unit cells C for sound absorption. The unit cell C for sound absorption may have the form of a panel having a small thickness. A cross section of the unit cells C for sound absorption may be formed in a polygonal shape, a circular shape, or the like. In an example, the unit cells C for sound absorption may have a square prism shape or a rectangular prism shape. In an example, the shape of the unit cells C for sound absorption is not limited to the rectangular prism shape, and may have another shape such as a polygonal prism shape or an oblique prism shape.

In an example, the unit cell C for sound absorption may include at least two resonators having different resonance frequencies. In an example, 2n resonators 100 (where, n is a natural number) may be included in the unit cell C for sound absorption. In an example, the unit cell C for sound absorption may include two resonators 100 having different resonance frequencies as a pair. One or more pairs of resonators 100 may be included in the unit cell C for sound absorption. A pair of resonators 100 may have different shapes or dimensions to function as one resonator when resonance occurs.

In an example, one unit cell C for sound absorption may be provided. Alternatively, a plurality of unit cells C for sound absorption may be provided. When the plurality of unit cells C for sound absorption are provided, the unit cells C for sound absorption may be arranged periodically on a plane. The plurality of unit cells C for sound absorption may be arranged to enable the resonators included in a pair to be operated at different frequency bands. This configuration may allow the sound absorbing apparatus 10 to achieve broadband sound absorbing performance enabling simultaneous sound absorption at multiple frequencies.

In an example, a pair of resonators 100 may be disposed diagonally relative to each other. Alternatively, a pair of resonators 100 may be disposed to be parallel to each other in a z-axis direction. Alternatively, a pair of resonators 100 may be disposed to be parallel to each other in a y-axis direction.

In an example, the resonators 100 having different resonance frequencies may be arranged alternately in a first direction, and the resonators 100 having the same resonance frequency may be disposed in a second direction perpendicular to the first direction. In one example, the first direction is the z-axis direction and the second direction is the y-axis direction. Accordingly, the resonators having different resonance frequencies may be arranged diagonally relative to each other.

Alternatively, the resonators 100 having different resonance frequencies may be arranged in a checkerboard pattern by being disposed alternately in the first direction and the second direction.

In the example described above, the resonators 100 are described as being arranged in a particular manner. However, the resonators 100 need not be adjacent to each other, only need to be disposed at a distance sufficient to cause resonance with each other, and may not be arranged in the particular manner.

In an example, one unit cell C for sound absorption may be provided, or a plurality of unit cells C for sound absorption may be provided. In an example, when the plurality of unit cells C for sound absorption are provided, the unit cells C for sound absorption may be arranged periodically.

In an example, two types of resonators, a first resonator 101 and a second resonator 102, which are included in a pair of resonators 100, may be provided. In an example, each of the first resonator 101 and the second resonator 102 may be a Helmholtz resonator. The Helmholtz resonator is a device that absorbs sound by resonating air at a specific frequency, formed in a closed shape having a neck, and operated based on a principle in which sound is absorbed due to frictional heat loss occurring when air passes through a small hole passing through the neck.

Here, four resonators 100 may be arranged in such a way that different types of resonators 101 and 102 are adjacent to each other in one direction. For example, each of the plurality of resonators 100 arranged on a plane may be arranged to have different resonance frequencies from the resonators adjacent thereto in at least one direction.

However, alternatively, the resonators 100 may be disposed randomly within the unit cell C for sound absorption at the distance sufficient to cause resonance with each other. For example, at least two resonators 100 may be disposed without following any specific rule, as long as the resonators are spaced from each other sufficiently to cause resonance with each other within the unit cell C for sound absorption. Although only four resonators 100 are shown in the drawing, the number of resonators 100 is not limited thereto.

Each resonator 100 may have its own resonance frequency. In general, the Helmholtz resonator may resonate at the specific frequency and absorb sound of the corresponding frequency. The first resonator 101 and the second resonator 102 may have different resonance frequencies, and the two resonators 101 and 102 may thus be operated at different frequency bands. In this way, the two resonators 101 and 102 may be operated differently, thereby effectively absorbing noise in various frequency ranges. When the resonators 101 and 102 having different resonance frequencies are disposed to be adjacent to each other, the resonators 101 and 102 may process different frequency bands, respectively, thereby achieving a sound absorption effect at a broader frequency range.

For example, the first resonator 101 and the second resonator 102 may have different resonance structures, and accordingly, a sound wave reflected from the first resonator 101 and a sound wave reflected from the second resonator 102 may have opposite phases and cause destructive interference, and the sound absorbing apparatus 10 may implement perfect sound absorption.

In an example, the unit cells C for sound absorption may be arranged in a lattice pattern. For example, the plurality of resonators 100 may be arranged in the lattice pattern on a plane perpendicular to a sound wave incident on the resonator, to make a reflection rate of the incident sound wave at the specific frequency zero.

The unit cell C for sound absorption may have a predetermined horizontal length D1, a predetermined vertical length D2, and a predetermined thickness H. In an example, the unit cell C for sound absorption may have a shape such as the polygonal prism shape, the oblique prism shape, the rectangular prism shape, or the square prism shape.

In an example, each resonator 100 may include a neck portion 110 and a cavity portion 120.

The neck portion 110 may have a predetermined thickness 11, and include a neck 111 communicating an exterior with the cavity portion 120. In an example, the neck 111 may be provided as a communication hole in the shape of a cylindrical tube. Alternatively, the neck 111 may be provided as a communication hole in the polygonal prism shape. Alternatively, the neck 111 may have a twisted shape. The neck 111 is not limited to such a shape, and may have various shapes for communicating the neck portion 110 with the cavity portion 120. The area or shape of the neck portion 110 is not limited to the examples described above, because the neck portion 110 only needs to be able to communicate the exterior with the cavity portion 120.

The neck 111 may penetrate through the neck portion 110. The cavity portion 120 may include a cavity including a space 121 therein. The space 121 may be open at the neck 111, and have a rear surface closed by a body having a predetermined thickness. In an example, the cavity portion 120 may have the polygonal prism shape. In an example, the cavity portion 120 may have the rectangular prism shape. However, the shape of the cavity portion 120 is not limited to the rectangular prism shape, and may have various shapes having a predetermined volume. The area or shape of the cavity portion 120 is not limited to the examples described above, because the cavity portion 120 only needs to have a hollow space therein.

In an example, a cross-sectional area of the neck portion 110 may be smaller than a cross-sectional area of the cavity portion 120.

The neck 111 may face a direction in which a sound wave W is incident. In the specification, the direction in which the sound wave W is incident is defined as “forward”, and an opposite direction is defined as “rearward”. In an example, the communication hole included in the neck 111 may have a circular cross-section perpendicular to a penetration direction.

The neck 111 may have a circular cross-section having a predetermined size and extend to connect the exterior of the unit cell C for sound absorption with the cavity portion 120, and have a predetermined diameter 2r. In an example, a length 11 of the neck 111 (in an x-axis direction) may be smaller than a length 12 of the space 121 (in the x-axis direction).

In an example, the neck 111 may be provided with a cover 112 capable of opening and closing the cross-section of the neck 111. In an example, the cover 112 may partially or entirely cover the cross-section of the neck 111. In an example, the cover 112 may include a hole 114 to block an opening of the neck 111 partially rather than completely.

In an example, the cover 112 may adjust an opening ratio of the neck 111. That is, the cover 112 may adjust a cross-sectional area of the opening of the neck 111. In an example, the cover 112 may be manufactured in a thin plate shape. In an example, the cover 112 may not have a uniform thickness. In an example, the cover 112 may be bumpy rather than flat. The thickness or shape of the cover 112 is not limited to the examples described above, because the cover 112 only needs to be able to partially or entirely cover the opening of the neck 111.

The cover 112 may include the hole 114. A size of the hole 114 may be adjusted to change the cross-sectional area of the neck 111, thereby adjusting the resonance frequency. In an example, the hole 114 may be disposed at the center of the cover 112. In another example, the cover 112 may not be disposed at the center of the hole 114. In an example, the cover 112 may not have a circular shape that exactly fits the opening of the neck 111, and may be modified to have various shapes. In an example, the cover 112 may only partially cover the neck 111. Alternatively, the cover 112 may entirely cover the neck 111. In an example, a plurality of covers 112 may be provided. For example, the plurality of covers 112 may be provided, and the plurality of covers 112 may be combined to partially or entirely cover the neck 111. In an example, movement directions of the plurality of covers 112 may be different from each other.

In an example, the cover 112 may be coupled to a front of the neck 111. In an example, the cover 112 may be detachably mounted to the front of the neck 111. Alternatively, the cover 112 may be mountable to and detachable from the rear of the neck 111. If the cover 112 is detachably mounted to the front or rear of the neck 111, the cover 112 may be easily replaceable, mountable, or detachable.

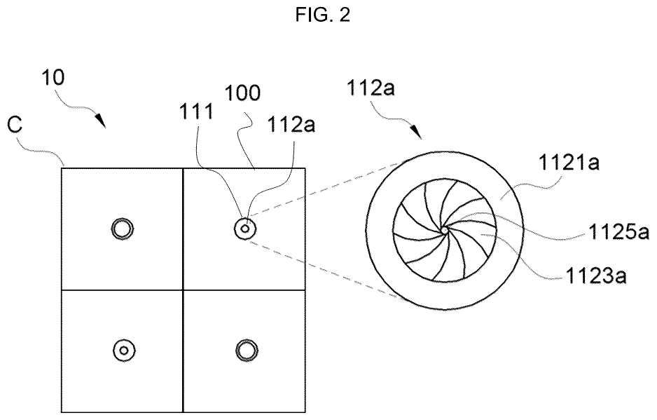

In an example, the cover 112 has an aperture shape that allows adjustment of the opening ratio. FIG. 2 shows an appearance of an aperture 112a according to an embodiment of the present disclosure.

In an example, the aperture 112a may be mounted at the front opening of the neck 111. The aperture 112a may include a ring 1121a and a vane 1123a. In an example, the ring 1121a may be mounted at a front of the unit cell C for sound absorption near an inner diameter of the neck 111 or the front opening of the neck 111. At least one plate-shaped vane 1123a may be combined to form a hole 1125a or close the neck 111. In an example, the hole 1125a may be formed at the center of the plurality of plate-shaped vanes 1123a. Alternatively, the plurality of holes 1125a may be formed. In addition, the hole 1125a may be formed at a position other than the center of the vane 1123a. The hole 1125a may have various shapes because the aperture 112a only needs to partially cover the neck 111. In an example, the hole 1125a may have a circular shape or a non-circular shape. In an example, movement radii of the respective vanes 1123a may be the same or different from each other.

In an example, the vanes 1123a may be combined to form the hole 1125a or close the neck 111. The aperture 112a may open or close the cross-sectional area of the neck 111 to a size desired by a user by moving the vanes 1123a to adjust the size of the hole 1125a. That is, the aperture 112a may change the cross-sectional area of the neck 111 by adjusting the size of the hole 1125a. In an example, the aperture 112a may be provided so that an operator may manually adjust the size of the hole 1125a. For example, a dial that moves the aperture 112a based on a manipulation may be provided. Alternatively, the aperture 112a may automatically adjust the size of the hole 1125a. For example, the sound absorbing apparatus may include an actuator for moving the aperture 112a and a controller for controlling the actuator. The controller may control the actuator to allow the hole 1125a to be sized to absorb the target frequency based on the ambient noise, as in an embodiment described below.

Each of the plurality of resonators 100 may have a different resonance structure from the adjacent resonator 100 in at least one direction. In an example, the necks 111 of the adjacent different resonators 100 may have different opening ratios.

For example, the apertures 112a of the first resonator 101 and the second resonator 102 may have different opening ratios. Alternatively, the covers 112 of the first resonator 101 and the second resonator 102 may have different positions, different shapes, or different thicknesses. Accordingly, the resonance frequencies of the first resonator 101 and the second resonator 102 may be set differently. Accordingly, hybrid resonance in which the two Helmholtz resonators resonate in the opposite phases at the target frequency may be induced, thereby achieving the perfect sound absorption in which all the reflected sound wave energy is dissipated in a near-field.

One resonator 101 may absorb the specific frequency while the other resonator 102 may absorb a different frequency when disposing two resonators 101 and 102 operated in different frequency bands to be adjacent to each other. This configuration may serve an important function in effectively absorbing noise in various frequency ranges and optimizing the resonance effect for the sound waves having various frequencies. This configuration may broaden a frequency band absorbed by each resonator 100 and enable the sound absorbing apparatus to exhibit high performance in various noise environments. In this way, the sound absorbing apparatus may perfectly absorb noise occurring at the specific frequency and have an advantage in processing sound waves having different phases or frequencies.

In the example described above, the cover 112 is described as being disposed at the front or rear of the neck 111. However, alternatively, the cover 112 may be disposed inside the neck 111.

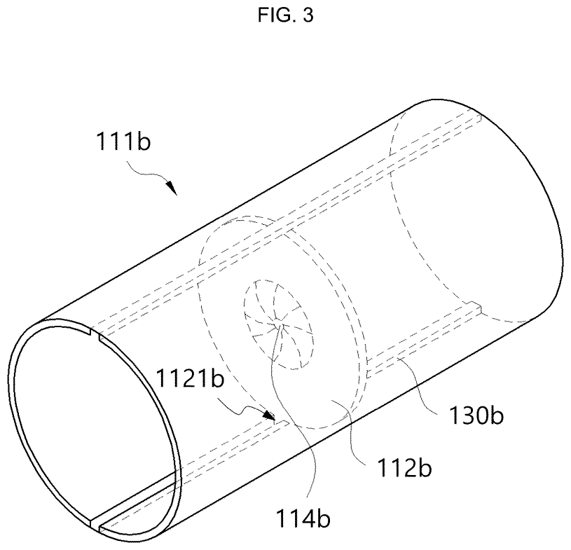

FIG. 3 shows an appearance of a neck 111b according to another embodiment of the present disclosure. Referring to FIG. 3, a cover 112b may be disposed at various positions in a length direction of the neck 111b within the neck 111b. In an example, the cover 112b may be movable in the length direction of the neck 111b within the neck 111b as needed. For example, a protrusion 1121b may be formed on the cover 112b, and a groove 130b corresponding to the protrusion 1121b may be formed within the neck 111b. The groove 130b may extend in the length direction of the neck 111b. The protrusion 1121b may be inserted into the groove 130b to allow the cover 112b to slide within the neck 111b. As the position of the cover 112b is changed, the resonance frequency may also be changed, and the resonance frequency may thus be adjusted by adjusting the position of the cover 112b. In an example, the position of the cover 112b may be manually changed by the user. Alternatively, an actuator for moving the cover 112b along the groove 130b may be provided. In an example, the actuator may automatically adjust the position of the cover 112b based on a signal from the controller described below, thereby implementing the optimal resonance frequency matching the ambient noise.

In an example, a plurality of covers 112b having different thicknesses may be provided. That is, the plurality of covers 112b having different volumes may be provided. The user may dispose and use the cover 112b having a desired thickness at the front side, rear side, or inside of the neck 111b as needed. For example, in order to effectively absorb a specific frequency band, the user may select a thickness of the cover 112b to implement the resonance frequency optimized for the corresponding frequency. If each cover 112b has a different thickness, the volume and resonance frequency of the neck 111b may differ, thereby enabling the sound absorbing apparatus to respond to the various frequencies.

In an example, the cover 112b may not have a uniform cross-sectional area along the length direction of the neck 111b, and the hole 114b may be formed at an edge rather than the center.

In an example, the plurality of covers 112b may be provided in one resonator 100. In an example, the plurality of covers 112b may be disposed within the neck 111b. In an example, the plurality of covers 112b may have different opening ratios, thicknesses, and shapes.

In an example, the sound absorbing apparatus 10 may further include a sensor and a controller. The sensor may detect the ambient noise around the sound absorbing apparatus 10 and transmit noise information to the controller. The controller may adjust at least one of the opening ratio or position of the cover 112b based on the noise information. For example, the controller may adjust the opening ratio of the cover 112b, adjust the position of the cover 112b, or simultaneously adjust the opening ratio and position of the cover 112b to implement the resonance frequency matching the noise environment based on the noise information.

In the example described above, the cover 112b is described as being coupled to the front or rear of the neck 111b or disposed within the neck 111b. However, alternatively, the cover 112b may not be directly coupled to the neck 111b and the opening ratio of the neck 111b may be adjusted.

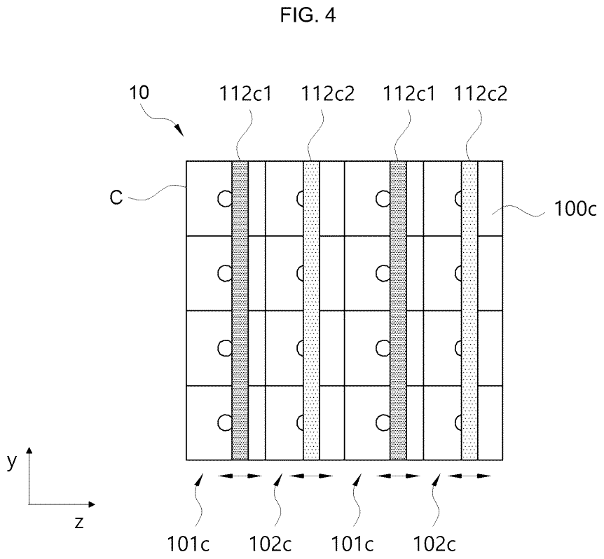

FIG. 4 shows an appearance of a cover 112c according to another embodiment of the present disclosure.

In an example, a first resonator 101c and a second resonator 102c may be disposed in the first direction, respectively. The first resonator 101c and the second resonator 102c may be disposed to be adjacent to each other in the second direction, which is the direction perpendicular to the first direction. In an example, each of the first resonator 101c and the second resonator 102c may include 2n unit cells C for sound absorption.

In an example, covers 112cl and 112c2 may be disposed at the front of each resonator 100 to be movable in the first direction (or the z-axis direction). In an example, the covers 112cl and 112c2 may extend in the second direction (or the y-axis direction) perpendicular to the first direction, and each has a size and a shape capable of collectively adjusting the opening ratio of the neck 111 of the resonator 100 disposed in the second direction. In an example, the covers 112cl and 112c2 may be mounted on a guiding rail to be movable in the first direction. The guiding rail may extend in the first direction, and an actuator for moving the covers 112cl and 112c2 may be provided on the guiding rail.

In an example, the covers 112c1 and 112c2 may include the first cover 112c1 corresponding to the first resonator 101c and the second cover 112c2 corresponding to the second resonator 102c. In an example, the first cover 112cl and the second cover 112c2 may have different movement ranges in the first direction, different widths in the first direction, or different shapes, thereby setting the resonance frequencies of the first resonator 101c and the second resonator 102c differently.

In the example described above, two pairs of identical resonators 100 having different resonance frequencies are provided, and a total of four resonators 100, which include two resonators 100 having different resonance frequencies, are provided. However, alternatively, four or more types of 2n resonators (where, n is a natural number), in which each resonator has a different resonance frequency, may be included in each pair. Such resonators 100 having different resonance frequencies may be arranged periodically on a two-dimensional plane.

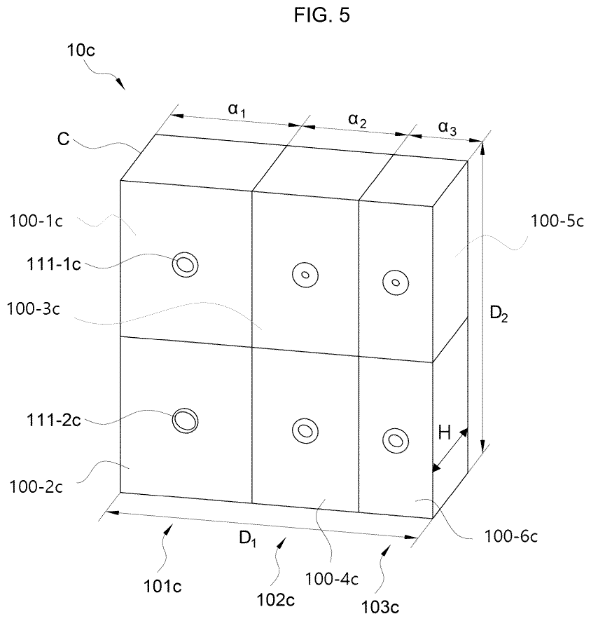

FIG. 5 shows an appearance of a sound absorbing apparatus 10c according to another embodiment of the present disclosure. In an example, three or more pairs of resonators 100 may be included in the unit cell C for sound absorption. FIG. 5 shows an embodiment in which three pairs of resonators 101c, 102c, and 103c are included in the unit cell C for sound absorption. In an example, six different types of resonators 100-1c, 100-2c, 100-3c, 100-4c, 100-5c, and 100-6c may be provided, and two different types of resonators 100-1c and 100-2c, 100-3c and 100-4c, or 100-5c and 100-6c may be paired to form one resonator 101c, 102c, or 103c, thereby providing a total of three pairs of resonators 101c, 102c, and 103c.

In an example, the unit cell C for sound absorption may have the predetermined horizontal length D1, the predetermined vertical length D2, and the predetermined thickness H, and the respective pairs of resonators 101c, 102c, and 103c may have the same shape. In an example, the first resonator 101c may have a horizontal length of a1, a vertical length of D2/2, and a thickness of H; the second resonator 102c may have a horizontal length of a2, the vertical length of D2/2, and the thickness of H; and the third resonator 103c may have a horizontal length of a3, the vertical length of D2/2, and the thickness of H.

In an example, the resonators 101c, 102c, and 103c included in the respective pairs may have the same shape. However, the opening ratios of necks 111-1c and 111-2c may be different from each other. In an example, the necks 111-1c and 111-2c of the resonators 100-1c and 100-2c included in the first resonator 101c may have different opening ratios. The reason is that the simultaneous sound absorption at the multiple frequencies is possible by changing the opening ratios of the necks 111-1c and 111-2c of the resonators 101c, 102c, and 103c included in each pair and then arranging the resonators, thereby achieving the sound absorption at different target frequencies. A broadband sound absorbing apparatus may be implemented by appropriately adjusting the number and spacing of sound absorption peaks using this method, and the sound absorbing apparatus may have the broad absorption bandwidth and effectively perform broadband noise reduction. FIG. 5 shows three pairs of resonators 101c, 102c, and 103c. However, alternatively, more pairs of resonators 101c, 102c, and 103c having different resonance frequencies may be provided.

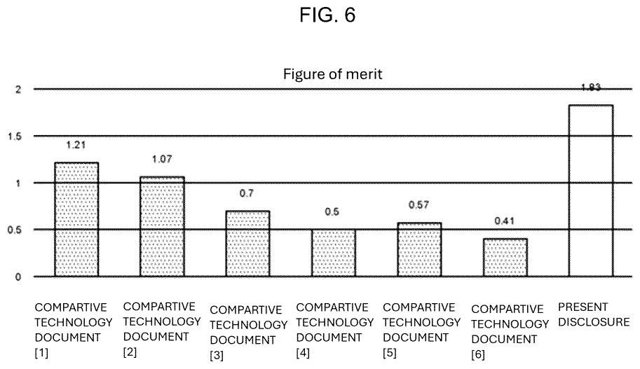

FIG. 6 is a graph comparing performance of the sound absorbing apparatus 10 according to an embodiment of the present disclosure with performance of comparative sound absorbing apparatuses.

The sound absorbing performance of the apparatus according to the present disclosure is compared with the comparative sound absorbing apparatus using the hybrid resonance. The figure of merit (FOM) is used as an index for evaluating the sound absorbing performance, which indicates how high a sound absorption rate may be achieved over how broad a frequency band and how the small thickness structure may be implemented. The FOM is calculated by the following equation.

$$FOM = {α}_{avg} \times \frac{Δ {f}_{α \geq 0.9}}{{f}_{c}} \times \frac{{λ}_{ma x}}{{V}^{1 / 3}}$$

Here, α_{avg} represents an average sound absorption rate within a sound absorption rate band of 90% or more, αf_{α≥0.9} represents a width of the sound absorption rate band of 90% or more, f_{c} represents a center frequency of the sound absorption rate band of 90% or more, λₘₐₓ represents the longest wavelength in the sound absorption rate band of 90% or more, and V represents a volume of the sound absorbing apparatus.

FIG. 6 shows the result of comparing the FOM of the example hybrid resonance device with that of the device according to the present disclosure. Comparative technology documents [1], [2], and [3] refer to a subwavelength Helmholtz resonator, a Helmholtz resonator including a twisted structure in an inner space, and a simple resonance acoustic metasurface having a membrane coupled into an inner space, respectively. Comparative technology document [4] shows a hybrid resonance acoustic metasurface based on a membrane resonator, and comparative technology documents [5] and [6] refer to a hybrid resonance device having a different neck radius of the Helmholtz resonator and a hybrid resonance device having non-uniformly divided cavity spaces, respectively.

The sound absorbing apparatus 10 according to the present disclosure, designed as shown in FIG. 1, may have a higher FOM value than that of the comparative acoustic metasurface. This result shows that the present disclosure may achieve high sound absorption of a sound absorption rate of 0.9 or higher in a broader frequency band while having a smaller thickness than not only a conventional porous material but also the acoustic metasurface. In addition, in the sound absorbing apparatus 10 according to the present disclosure, combinations of the neck opening ratios for achieving the perfect sound absorption at the target frequency may be continuously distributed. Therefore, the sound absorbing performance of the sound absorbing apparatus according to the present disclosure may not be significantly deteriorated by manufacturing tolerance compared to comparative technology documents [5] and [6], which may achieve the perfect sound absorption only by a specific combination of the radius of the neck 111 or the membrane position. The sound absorbing apparatus according to the present disclosure may have various combinations of the neck opening ratio for achieving the perfect sound absorption at the target frequency, thus making it possible to derive an optimal design by selecting the design that enables the broadest sound absorption bandwidth.

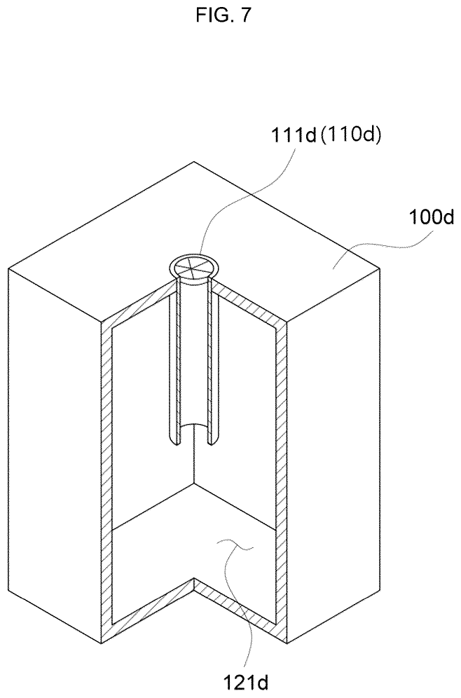

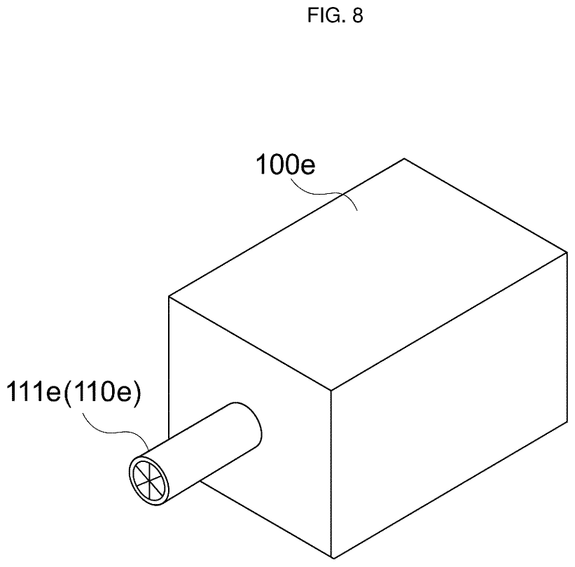

In the example described above, the neck portion 110 is described as having the predetermined thickness. However, alternatively, the neck portion 110 may only have the cylindrical neck 111. For example, as shown in FIG. 7, a neck portion 110d formed in a resonator 100d may be a neck 111d inserted toward a cavity 121d. Alternatively, as shown in FIG. 8, a neck portion 110e formed in a resonator 100e may be a neck 111e protruding externally from the resonator 100e. A shape of the neck portion 110e is not limited thereto, and include various shapes capable of connecting the cavity 121e with the exterior.

The resonance frequency of the resonator 100 may vary depending on the diameter or length of the neck 111, the volume of the space, or the like. An already manufactured Helmholtz resonator may be operated to resonate only at the specific frequency, and thus be unable to respond to the various frequencies unless its structure is changed. The present disclosure may provide the cover 112 capable of adjusting the cross-sectional area of the neck 111 or its position within the neck 111, thereby enabling the resonator to respond to the various frequencies without changing the structure of the Helmholtz resonator.

In addition, the sound absorbing apparatus according to the present disclosure may reduce or minimize noise such as transformer noise occurring at a data center in an urban area.

In addition, the sound absorbing apparatus according to the present disclosure may exhibit the excellent sound absorbing performance while having the small thickness, and achieve the multiple-frequency and broadband sound absorption by using the broad absorption bandwidth.

In addition, the sound absorbing apparatus according to the present disclosure may adjust the resonance frequency based on the ambient noise by using the cover capable of adjusting the neck opening ratio, thereby effectively solving noise control problems occurring in various industries.

In addition, the sound absorbing apparatus according to the present disclosure may achieve the high sound absorption based on the broad bandwidth in the low-frequency band of several hundred Hz, and adjust the optimal sound absorption frequency within the frequency range by using the simple adjustment method.

Although the embodiments of the present disclosure are shown and described as above, the embodiments of the present disclosure are not intended to limit the spirit of the present disclosure, but rather to describe the same. Accordingly, the spirit of the present disclosure includes not only each disclosed embodiment but also combinations of the disclosed embodiments. Furthermore, the scope of the present disclosure is not limited to these embodiments. In addition, the present disclosure may be variously changed and modified by those skilled in the art to which the present disclosure pertains without departing from the spirit and scope of the appended claims, and all such appropriate changes and modifications should be considered equivalent and fall within the scope of the present disclosure.

What is claimed is:

1. A sound absorbing apparatus comprising a unit cell for sound absorption,
wherein the unit cell for sound absorption includes at least two resonators having different resonance frequencies,
wherein the resonators comprise:
a cavity portion having a hollow space therein,
a neck portion connected to the cavity portion and having a neck communicating the space to an exterior, and
a cover for adjusting a neck opening ratio, and
wherein the resonators included in the unit cell for sound absorption have different resonance frequencies by having one of (a) different neck opening ratios set by the cover, (b) different cover positions, or (c) different cover shapes or thicknesses.

2. The apparatus of claim 1, wherein the cover partially or entirely opens or closes the neck.

3. The apparatus of claim 1, wherein one cover is provided, or a plurality of covers are combined to adjust the neck opening ratio.

4. The apparatus of claim 1, wherein the cover is provided as an aperture structure in which at least one plate-shaped vane is combined to form at least one hole, and a cross-sectional area of the neck is changeable by moving the vane to adjust a hole size.

5. The apparatus of claim 1, wherein one unit cell for sound absorption is provided.

6. The apparatus of claim 1, wherein the plurality of unit cells for sound absorption are arranged periodically on a plane.

7. The apparatus of claim 1, wherein the resonators are randomly disposed within the unit cell for sound absorption at a distance sufficient to cause resonance with each other.

8. The apparatus of claim 6, wherein the resonators having different resonance frequencies are arranged alternately in a first direction,
wherein the resonators having the same resonance frequency are disposed in a second direction perpendicular to the first direction, and
wherein the resonators having different resonance frequencies are arranged diagonally relative to each other.

9. The apparatus of claim 6, wherein the resonators having different resonance frequencies are disposed alternately in the first direction and the second direction.

10. The apparatus of claim 9, wherein the cover extends in the second direction, has a size and a shape capable of collectively adjusting the neck opening ratio of the resonator disposed in the second direction, and is movable in the first direction.

11. The apparatus of claim 10, further comprising:
a guiding rail on which the cover is mounted and which extends in the first direction; and
an actuator for moving the cover in the first direction on the guiding rail.

12. The apparatus of claim 1, wherein the cover is coupled to the front or rear of the neck.

13. The apparatus of claim 1, wherein the cover has a plate shape having a hole formed therein, and is disposed within the neck.

14. The apparatus of claim 13, wherein the cover is movable within the neck.

15. The apparatus of claim 14, wherein a protrusion is formed on the cover,
wherein a groove is formed within the neck along a length direction of the neck to correspond to the protrusion, and
wherein the cover slides along the groove.

16. The apparatus of claim 1, wherein a cross-sectional area of the neck portion is smaller than a cross-sectional area of the cavity portion.

17. The apparatus of claim 1, further comprising:
a noise sensor for measuring ambient noise; and
a controller for controlling the cover to adjust the neck opening ratio based on noise measured using the noise sensor,
wherein the controller adjusts the neck opening ratio or a position of the cover within the neck to implement an optimal resonance frequency matching the ambient noise.
